(19) United States
(12) Patent Application Publication
(10) Pub. No.: US 2008/0006653 A1
(43) Pub. Date: Jan. 10, 2008

(54) SMALL VOLUME LIQUID HANDLING SYSTEM

(75) Inventors: Zheng-Shan Dai, Chapel Hill, NC (US); Xue-Feng Wang, Chapel Hill, NC (US); Richard Brinsley Sheridan III, Cary, NC (US)

Correspondence Address: Marianne Fuierer;Moore & Van Allen PLLC, PO Box 13706, RTP, NC, 27709, US

(73) Assignee: BIOMACHINES, INC., RTP, NC (US)

(21) Appl. No.: 11/685,464

(22) Filed: Mar. 13, 2007

Related U.S. Application Data
(60) Provisional application No. 60/781,932, filed on Mar. 13, 2006.
(60) Provisional application No. 60/811,319, filed on Jun. 6, 2006.

(51) Int. Cl. B67D 5/12; B67D 5/14

(52) U.S. Cl. 222/75; 901/16; 222/52

(57) ABSTRACT

The present invention relates to non contact, vision (imaging device/camera) guided, vision-enabled, solenoid valve liquid dispensing systems and methods of using same for automation of complex laboratory workflows and especially useful for a variety of biomedical and other applications including automated front-end sample preparation for matrix assisted laser desorption/ionization (MALDI) mass spectrometry analysis.

### CROSS REFERENCE TO RELATED APPLICATIONS

This application claims priority to U.S. Provisional Application No. 60/781,932 filed on Mar. 13, 2006 and U.S. Provisional Application No. 60/811,319 filed on Jun. 6, 2006, the contents of which are hereby incorporated herein by reference for all purposes.

### BACKGROUND OF THE INVENTION

1. Field of the Invention

This invention relates to automated methods and systems for small volume liquid dispensing, and more particularly, to vision (imaging device/camera) guided and solenoid valve dispensing systems and methods usable for a variety of biomedical and other applications.

2. Description of Related Art

Nanoliter liquid handling has become an important technology area because increasingly there are requirements for handling very small volumes of a variety of liquids in high throughput drug discovery, medical diagnostics, basic scientific research, and many other biomedical applications. Historically, small volume liquid handling applications were limited to dispensing in pre-defined row column matrices embodied by 96, 384, and 1536 well microtiter plates or higher density arrays. As the plate densities increased, the desired dispense volumes decreased, and technology development has focused mainly on improving small volume liquid handling over the range of 5-100 nanoliters.

Two basic technologies for small volume liquid handling are contact printing and non-contact liquid handling. Both technologies may employ automated robotic systems. Contact printing can work well with small volumes of liquid, but because of physical contact can damage the surface of a substrate or can destroy an object on the surface of a substrate, such as tissue. Non-contact liquid handling systems for very small and small volumes (i.e., picoliter to nanoliter) typically incorporate piezo actuators similar to inkjet techniques, or very high speed solenoid valves, depending on the desired dispense range. Theoretically, piezo based liquid handling techniques should be competitive with contact printers in microarray dispensing; however, piezo dispensers have issues related to clogging, cross contamination, sensitivity to barometric pressure, and other practical issues, especially incompatibility with certain chemical and biological materials.

Recently, automated small volume liquid handling has become important because of the need for high speed in large scale, high throughput operations. Automated small volume liquid handlers repeatedly dispense a reagent, solvent, or sample into an object container (e.g., high density microtiter plate, or array substrate). Existing liquid handlers are limited by reliability and ease-of-use issues which negatively impact both performance and function.

Although the trend for miniaturization for liquid handling has increased the requirement for precision of automated robotic systems, emerging applications in the biomedical field also require increasing flexibility in placement and patterning of drop depositions (e.g., tissue mass spectrometric imaging applications). In addition, two recent trends are driving technology development for automated small volume liquid handling: (1) There is increasing need to dispense low or sub-nanoliter volumes to conserve rare or precious materials; and (2) there is increasing need to dispense small volumes at specific or operator defined locations for a variety of regular and irregular substrates (e.g., tissue microarrays or tissue slices dried onto matrix-assisted laser desorption/ionization (MALDI) targets). The performance and reliability of a solenoid valve based dispenser has heretofore generally been limited to reliable dispensing over the range of 10's to 100's of nanoliters.

For the foregoing reasons, there is a need for development of reliable, easy-to-use, accurate, and flexible small volume liquid handling techniques and devices. Among other areas, a variety of biomedical applications may benefit from such techniques and devices, especially in the fields of genomics, proteomics, and high content cell biology studies.

### SUMMARY OF THE INVENTION

The present invention relates to vision-enabled, small volume liquid delivery systems and methods of using same for automation of complex laboratory workflows and especially useful for automating front-end sample preparation for matrix assisted laser desorption/ionization (MALDI) mass spectrometry analysis.

In one aspect, the present invention relates to a system that integrates vision with small-volume dispensing comprising:
a platform having a base and support arms positioned on opposite sides of the platform, wherein the support arms rise above the platform base;
a carriage structure positioned on the support arms and having directional movement thereon;
a control unit positioned on the carriage structure and having movement along at least a portion of the carriage structure span;
a liquid handling dispensing assembly in communication with the control unit having Z motion and positioned above the platform;
a imaging device positioned adjacent to the liquid handling dispensing assembly;
a working surface positioned below the carriage structure; and
an illumination system positioned above and/or below the working surface.

Another aspect of the present invention relates to an imaging device guided small volume liquid handling apparatus for use in deposition of liquids onto an object or substrate in accordance with a specified pattern comprising:
(1) a platform having a flat surface and have at least one support rising above the flat surface of the platform:
(2) a movable carriage positioned above the platform and connected to the at least one support;
(3) a modular assembly connected to the movable carriage comprising:
(4) a dispensing unit comprising
   (i) a high speed solenoid valve;
   (ii) a reservoir downstream of the solenoid valve;
   (iii) an orifice fitted to the downstream end of the solenoid valve; and
   (iv) a connector connected to a valved pressure system and an aspiration device; and
   (v) (2) a Z axis drive for moving the dispensing unit in the Z direction;
   (vi) (3) an imaging device; and
(5) a solenoid valve electronic control circuit for control of the dispensing unit.

In yet another aspect, the present invention relates to a method for dispensing small volumes of liquid comprising:
(1) providing a pneumatic pressure valve in communication with a pneumatic-hydraulic system;
(2) closing the pneumatic pressure valve;
(3) providing an aspiration device in pneumatic-hydraulic communication with the pneumatic-hydraulic system downstream of the pneumatic pressure valve;
(4) aspirating system prime fluid into the system until is it downstream and upstream of a solenoid dispense valve;
(5) aspirating dispense fluid into the system, remaining downstream of the dispense valve;
(6) opening the pneumatic pressure valve;
(7) backing the solenoid valve with pneumatic pressure;
(8) applying pressure to the system to initialize relatively large droplet size dispenses; and
(9) reducing the pressure and the valve opening pulse width to the final dispensing parameters.

A still further aspect relates to a camera calibration and image processing method comprising:
(1) mounting a video camera on the X,Y carriage of a Cartesian robot including a robot platform, the camera having a diagonal field of view (FOV);
(2) moving the camera towards a camera calibration target which is a fraction of the diagonal of the FOV of the camera;
(3) finding the center of gravity of the target with image processing software;
(4) moving the camera step-by-step through an array that starts with the target in one corner of the FOV and ends when the target is in the opposite corner of the FOV;
(5) acquiring the image of the target; and
(6) recording the center of gravity.

In another aspect the present invention relates a method for calibrating droplets, the method comprising:
(1) moving the dispense orifice the robot to a imaging device calibration station;
(2) dispensing one or more droplets, first done in an initial dispense process;
(3) taking the image of the droplets;
(4) calculating the relative position between the imaging device and the dispense nozzle and moving the dispense orifice in the appropriate Z direction.

In yet another aspect, the present invention relates to a dispensing unit comprising:
(1) a solenoid valve having a frequency of about 800 HZ to about 1400 Hz;
(2) a short liquid reservoir tubing downstream of the valve communicatively connected to the valve and a sapphire orifice nozzle through with the device aspirates and dispensing liquid;
(3) an interface tube located upstream of the solenoid valve containing a small volume of prime fluid so that a certain small volume of fluid is maintained above and below the solenoid valve during dispensing, so that during operation the dispense fluid is stored in the reservoir tubing and is not allowed to enter the solenoid valve in order to prevent clogging and physically or chemically interacting with the internal components of the valve.

A method for dispensing small volume liquids with imaging thereof, the method comprising:
providing an X,Y carriage of a Cartesian robot that includes a platform;
mounting a camera on the X,Y carriage;
mounting a dispensing device on the on the X,Y carriage;
imaging an object or substrate with the camera;
defining or importing and overlaying a dispense pattern for the object or substrate image; and
executing a dispensing protocol in which droplets are dispensed from the dispensing device at the same or different locations on the physical object or substrate in accordance with the pattern specified for the image.

Various other aspects, features and embodiments of the invention will be more fully apparent from the ensuing disclosure and appended claims.

### BRIEF DESCRIPTION OF THE DRAWINGS

FIG. 1 shows a perspective view of an imaging device guided non-contact small volume liquid handling system in accordance with an embodiment of the present invention.

FIG. 2 shows a flow chart in accordance with a camera calibration process in accordance with the system of FIG. 1.

FIG. 3 shows a schematic diagram of a pneumatic and hydraulic system in accordance with the system of FIG. 1.

FIG. 4 shows a section view of a liquid handling device in accordance with the system of FIG. 1.

FIG. 5 a perspective view of a pneumatic and hydraulic implementation in the dispense head of the system of FIG. 1.

FIGS. 6 and 7 show front and rear perspective views of the dispense head of the system of FIG. 1.

FIG. 8 shows a flow chart in accordance with a dispense implementation process in accordance with the system of FIG. 1.

FIG. 9 shows a flow chart in accordance with a nozzle calibration process in accordance with the system of FIG. 1.

FIG. 10 shows an elevation view of the illumination apparatus of the system of FIG. 1.

FIG. 11 shows an elevation view of an illumination apparatus configuration in accordance with another embodiment of the present invention.

FIG. 12 shows a schematic diagram of a dispense valve control circuit in accordance with an embodiment of the present invention.

FIG. 13A shows an exemplary signal diagram for the dispense valve control circuit of FIG. 12 for nanoliter dispensing in accordance with the system of FIG. 1.

FIG. 13B is an exemplary signal diagram for the dispense valve control circuit of FIG. 12 for microliter aspiration in accordance with the system of FIG. 1.

FIG. 14 is an example of a spike hold circuit in accordance with an embodiment of the present invention.

FIG. 15 illustrates operation of the spike control circuit of FIG. 14 and shows a voltage signal applicable to a dispense valve in response to the input voltage signal shown.

FIG. 16 shows sample images and spot arrays produced in accordance with an embodiment of the present invention.

### DETAILED DESCRIPTION OF THE INVENTION

The present invention will be described in terms of specific, example embodiments. It is to be understood that the invention is not limited to the example embodiments disclosed. It should also be understood that not every feature of the devices or methods described are necessary to implement the invention as claimed in any particular one of the appended claims. Various elements, steps, processes, and features of various embodiments of devices and processes are described in order to fully enable the invention. Throughout this disclosure, where a process or method is shown or described, the steps of the method may be performed in any order or simultaneously, unless it is clear from the context that one step depends on another being performed first.

In the Figures herein, unique features receive unique reference numerals, while features that are the same in more than one drawing receive the same reference numerals throughout. Further, certain terms of orientation may be used, such as “front,” “back,” “interior,” “top,” “bottom,”“left,” “right,” “vertical,” and “horizontal.” These terms are generally for convenience of reference, and should be so understood unless a particular embodiment requires otherwise.

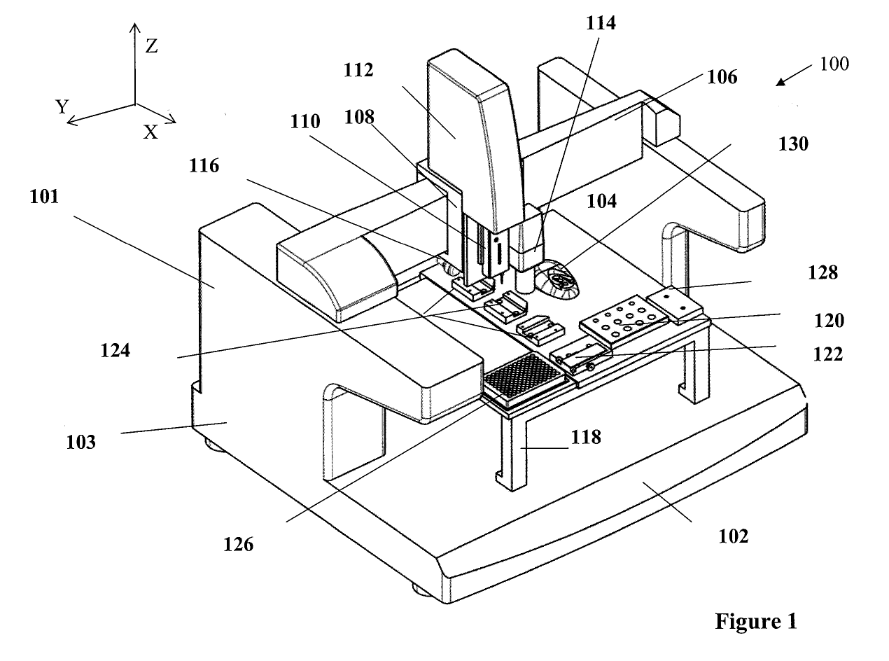

Referring now to the drawings, an embodiment of an imaging device guided automated liquid handling system 100 in accordance with the present invention is shown in FIG. 1. Herein, for convenience, the term “camera” is used, and should be understood to refer to any type of camera or imaging device or sensor as may be selected by one of ordinary skill in the art. In the system 100, there are several components including: a robot 101 including a high precision Cartesian three axis (XYZ) robot platform 102 with base supports 103, 104, an X,Y axes carriage 106, and a Z axis drive 108 riding on the X,Y carriage 106;; a liquid handling device control unit 112; a liquid handling dispense assembly and head 110 on the Z axis drive 108, wherein control unit 112 and/or 108 drive can move along the 106 carriage and the 106 carriage can move in the x direction along the 103 and 104 base supports; a camera imaging device 114; an illumination system 116; and a working surface plate 118 to hold different elements of operation components, such as sample holders 120, a slide holder 122, a target plate holder 124, reagent containers of microtiter plates and tubes 126, camera and nozzle calibration target 128, and ultrasonic bath 130.

The scope of the invention is not intended to be limited by materials or specific manufactured parts listed herein, but may be carried out using any materials that allow construction and operation. Materials, parts, and dimensions depend on the particular application. In general the materials of the components may be as appropriate for pneumatic, hydraulic, and electronic parts, as selected by one of ordinary skill in the art. All dimensions discussed herein are by way of example.

For the operation, there are several steps, including camera calibration, implementation of the dispensing protocol, nozzle calibration, image processing and liquid handling spot generation, liquid handling, and post-liquid handling.

### 1. Camera Calibration

As shown in FIG. 1, in one embodiment a camera-based imaging device 114, such as a video camera, is mounted on the X,Y carriage 106 of a high precision Cartesian robot 101, which has a closed loop linear motor with 1-micron resolution glass encoder. Although referred to as a camera herein, the imaging device 114 can be any kind of camera or image sensor. For example, charge-coupled devices (CCD) or complementary metal-oxide-semiconductor (CMOS) cameras may be used. The imaging device 114 may render a color or black-white image. In order to increase the detection sensitivity, other type of cameras like a cooled CCD or intensifier device can be used. In one embodiment, a color CCD video camera may be used, as manufactured by Sony Corporation, model no. DFW-X710, and the XYZ robotic platform 102 may be as manufactured by InfoTech AG of Solothurn, Switzerland. The camera 114 is used to acquire images of an object (e.g., tissue thin sections dried onto a MALDI target).

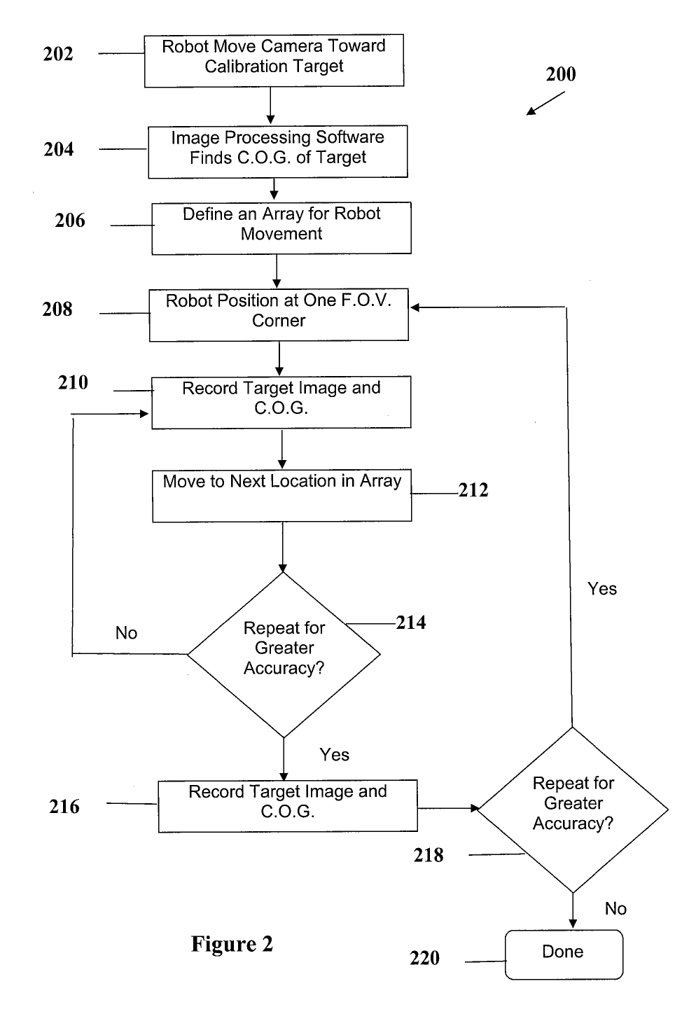

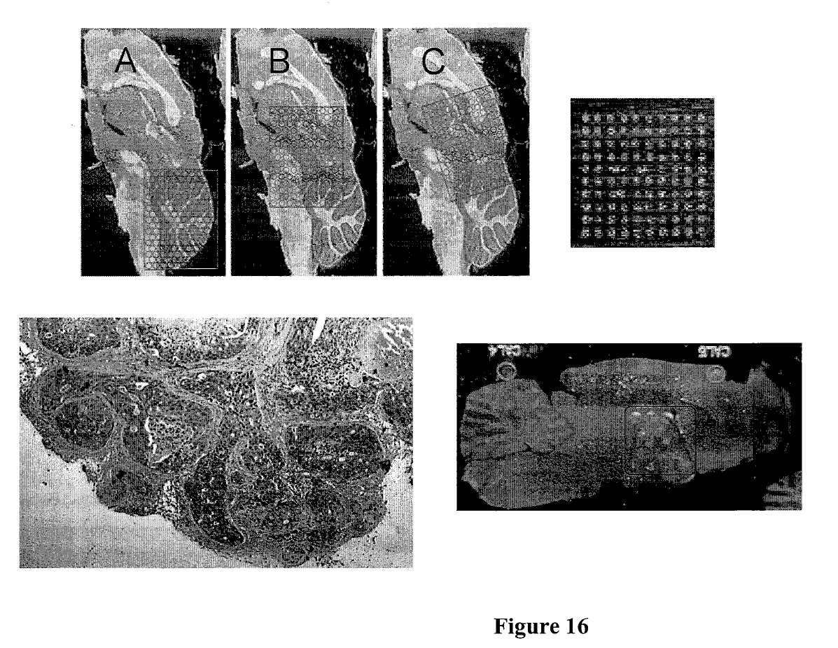

As shown in flow diagram of FIG. 2, during one embodiment of camera calibration 200, the robot 101 will move the camera 114 towards a camera calibration target 128. The target 128 may be a circle with diameter about 1/10 of the diagonal of the field of view (FOV) of the camera 114. Imaging processing software finds 204 the center of gravity (COG) of the target 128. An array is defined 206, by use of an appropriate software program as shown in FIG. 16, for robot 101 movement, and may be based on an accuracy requirement, and the robot 101 may move step by step to go through the array at 1-micron resolution. The robot 101 starts in position 208 with the target 128 in one corner of the FOV and ends when the target is in the opposite corner of the FOV. The image of the target 128 is acquired and the center of gravity is recorded 210. The robot moves to the next location in the array 212. If the robot 101 is at the opposite corner of the FOV 214, the image of the target 128 is acquired and the center of gravity is recorded 216 again, and a decision is made whether or not to repeat the process 218 to obtain greater accuracy or to be done 220.

All the images acquired will be reconstructed afterwards via warping the raw image from the target center of gravity array to the robot-moving array. Warping is a process that deforms images and in which positions in one plane are mapped to positions in another plane. The result may include removal of optical distortions that can result from camera lenses or viewing perspective. Images may be registered within an array. Multiple images may be aligned.

The center of gravity of the target may be determined from a distorted image. The center of gravity from the image of the target may be calibrated first in the image and then the center of gravity of the target may be calculated from the initial calibrated image data. A more accurate position calibration may be achieved than with conventional methods. For example, in one embodiment where the target is a circle about 1/10 the diagonal of the FOV, the inaccuracy of the center of gravity position from the image distortion of the target is about 1/10 of the target position inaccuracy in the whole image. Thus, about 90% of the geometric distortion will be removed after the first iteration. If higher positional accuracy is required, a second iteration of camera calibration can be performed with another 90% distortion removed from the image. Also, multiple iterations of camera calibration will further improve the imaging geometric accuracy.

Thus, with respect to image geometric accuracy, the imaging device/camera calibration process and imaging processing of the present invention may reduce geometric distortion of the image produced by the imaging optical system. On the other hand, many conventional machine vision systems find the feature position from the raw, distorted image captured by the camera. Then a more accurate position is calculated from a warp function with warp coefficients obtained from a process similar to that described above. However, since the calculation of the center of gravity is in raw data, there will be associated distortion and may be lower accuracy of the calibrated center of gravity position as compared with the method of the present invention.

Image processing is performed with the use of software from the Intel® Integrated Performance Primatives, Image Processing Function Domain (INTEL is a registered trademark of Intel Corporation), as may be selected and used by one of ordinary skill in the art.

### 2. Implementation of the Dispense

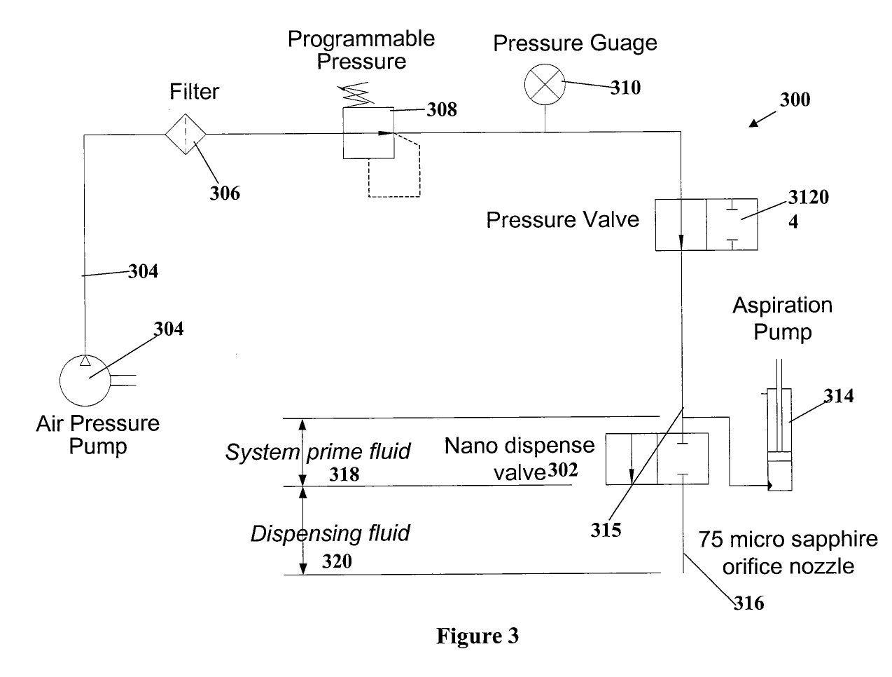

FIG. 3 is a diagram of an embodiment of a pneumatic-hydraulic system 300 used to aspirate specific liquids, to apply controlled pressure at the back of the dispense valve 302, and to open the dispense valve 302 at high frequency. The system 300 may include an air or otherwise pneumatic pressure pump 304, an air pressure line 305, a filter 306, a programmable pressure control 308, a pressure gauge 310, a pressure valve 312, an aspiration device (indicated as a pump) 314, the dispense valve 302, pneumatic-hydraulic lines 315, and an orifice nozzle 316 (indicated as 75 micro sapphire). System prime fluid 318 is disposed both upstream and downstream of the dispense valve 302, and dispensing fluid 320 is downstream of the prime fluid 318 to the nozzle 316.

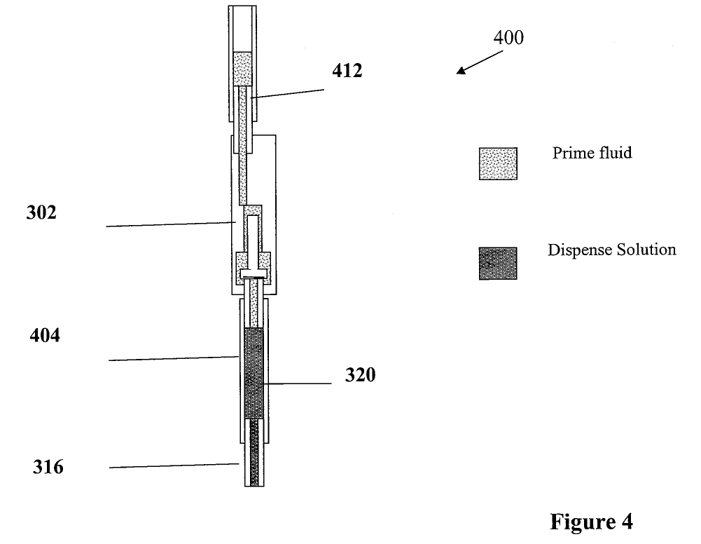

FIG. 4 shows one embodiment of liquid handling device 400 and the principle of operation. There may be three major components for the device configuration to contribute to implementing a non-contact sub-10 or sub-5 nanoliter dispense: (1) a very high frequency solenoid valve (for example, having a maximum frequency of about 800-1,400 Hz, or in some embodiments about 1,000-1,200 Hz), which is the dispense valve 302, (2) a short liquid reservoir tubing 404 downstream of the dispense valve 302 connecting the dispense valve 302 and a sapphire orifice nozzle 314 through which the device 400 aspirates and dispenses prime fluid 318 and dispense solution 320, and (3) an interface tube 412 located just upstream of the dispense valve 302 containing a small volume of prime fluid 318 so that a certain small volume of prime fluid 318 is maintained above and below the dispense valve 302 during dispensing (i.e., “minimally fluid filled”). The liquid handling device 400 may include a high speed solenoid dispense valve, model no. INKA2426212H, and orifice nozzle as manufactured by LEE Company of Westbrook, Conn.

An initial washing cleans residual material from a previous use and detects clogging in the liquid handling flow path. It may be necessary to wash the outer nozzle 316 using an ultrasound cleaner. When desired, the robot 101 may automatically move to an embedded ultrasonic washer 130, as shown in FIG. 1, and the software automatically executes a wash process. After cleaning, through computer software control, the dispense head 110 mounted with the liquid handling device 400 moves to a reagent reservoir 126.

One example of a prime fluid 318 is distilled water. Dispense fluid 320, on the other hand, may be harmful to the dispense valve 302. Accordingly, during operation the dispensing fluid 320 is stored in the reservoir tubing 404 and is not allowed to enter the dispense valve 302 in order to prevent clogging and physically or chemically interacting with the internal components of the valve 302. In tissue mass spectroscopic applications, Sinapinic acid (3,5-dimethoxy-4-hydroxycinnamic acid, or SA) is typically used for high molecular weight proteins while -cyano-4-hydroxycinnamic acid (HCCA) is more commonly employed for low molecular weight proteins or peptides. In operation of one embodiment, 10-30 mg/mL of SA concentrations can be used.

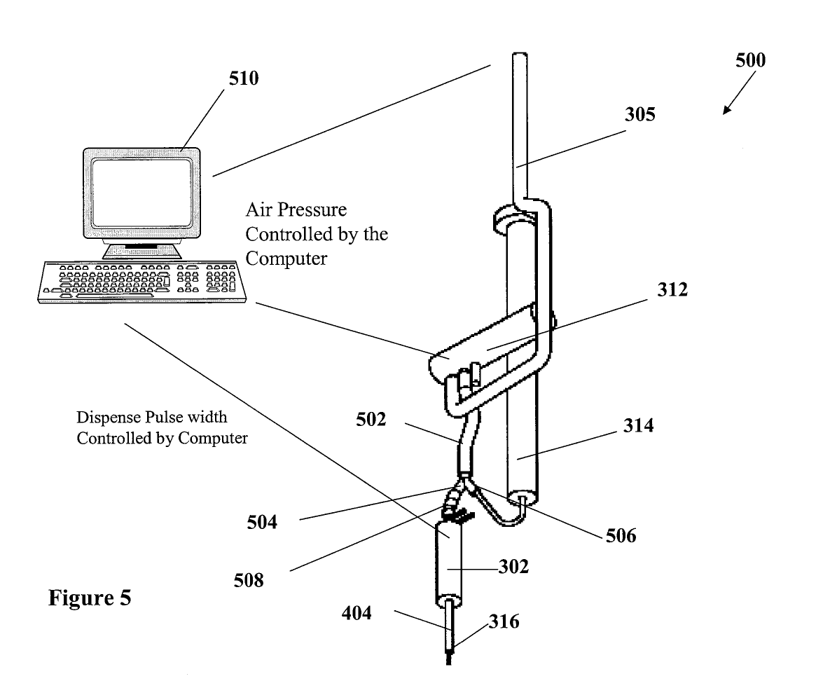

FIG. 5 shows an embodiment of a pneumatic and hydraulic connection arrangement 500 that is disposed inside the dispense head 110. The arrangement 500 includes air pressure tubing 305 connected to the air pressure valve 312. The air pressure valve is connected through pneumatic/hydraulic tubing 502 to a Y connector 504. One branch 506 of the Y connector 504 is connected to the aspiration syringe 314, and the other branch 508 is connected to the dispense valve 302. Tubing 404 connects the dispense valve to the orifice nozzle 316. As shown schematically, a computer 510 controls the air pressure to the air pressure tubing 305 and air pressure valve 312, and controls the dispense pulse width at the dispense valve 302.

In one embodiment a 15 mm long, 0.5 mm I.D. Teflon® (polytetrafluoroethylene) tube may be used to connect the nozzle 316 and the valve orifice and serve as the dispense fluid reservoir (TEFLON is a registered trademark of E.I. du Pont de Nemours and Company). About a 2.5 microliter volume in total may be formed based on use of this tube underneath the dispense valve orifice.

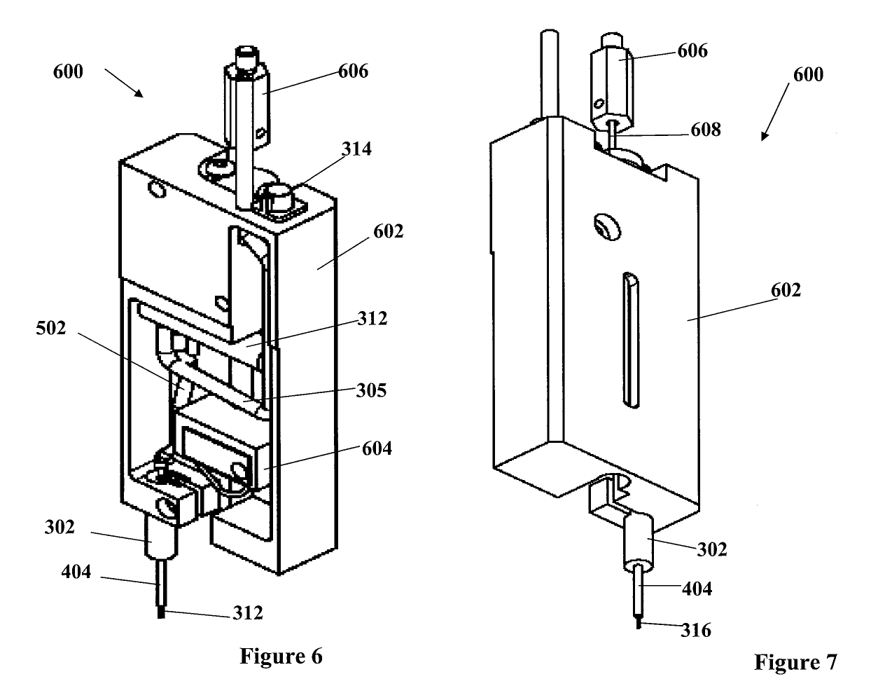

FIGS. 6 and 7 show that the dispense head 110 may be modular and packaged into an exchangeable unit 600. The unit 600 includes a casing 602 and electrical components 604, 606, 608, in addition to the pneumatic and hydraulic connection arrangement 500 of FIG. 5.

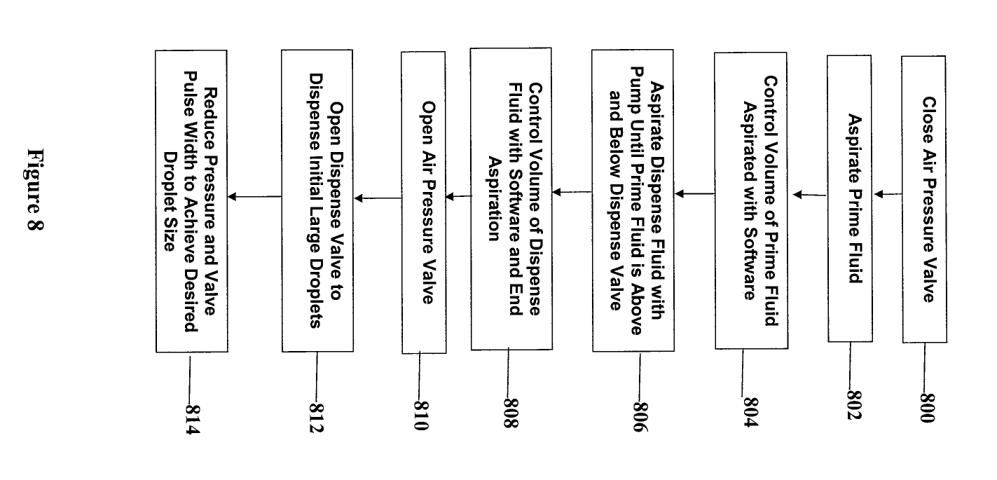

FIG. 8 shows a flow diagram of a process used to prepare the system 300, as shown in FIG. 3, before the dispensing. Before aspiration, 800 the air pressure valve 312 closes. System prime fluid 318 is first aspirated 802 into the system 300 using an aspiration pump, syringe 314, or other device that develops a vacuum, with the volume controlled by software 804. Then the prime fluid 318 is immediately followed 806 with the dispensing fluid 320. A 100 microliter syringe from Hamilton Company of Reno, Nev. may be used for liquid aspiration and dispensing operations. In the process, slow aspiration is recommended to make laminar aspiration flow which minimizes the mixing between the dispense solution 320 and the prime system fluid 318. Since dispense liquid 320 may harmful to the dispense valve 302, it may be desirable to aspirate sufficient dispense liquid 320 but not allow the dispensing liquid 320 to enter the dispense valve 302. In one embodiment, up to 2.5 microliters of dispense liquid can be aspirated into the dispense reservoir tubing 404, which is fitted with the nozzle 316. For liquid handling, reagents, samples, or solvents can be aspirated from a variety of source containers such as tubes, microwells, or Eppendorf type containers.

Reservoir tube 404 size may be used to control volume, along with the time the dispense valve 302 stays open or the time the pump or syringe 314 stays on, which is controlled by software. For lower volume nano liquid handling applications, to avoid the mixing interface, only 1 to 2 microliters of fluid may required for dispensing, which is configurable by the operator. For 1 nanoliter droplet size, about 1,000 to 2,000 spots can be dispensed. Longer Teflon tubing 404 can be used if larger droplets need to be dispensed. In one embodiment, after aspiration the system's pneumatic and hydraulic system's gas and liquid border will remain located just above the dispense valve, and may be located at a branch of the Y connector. The gas may be air, as generally referred to herein, or may be another gas as selected by one of ordinary skill in the art; reference to air, air pressure, and air pressure valves should be understood to refer to any gas. Thus, a certain small volume of prime liquid will stay above and below 806 the dispense valve 302 during dispensing (i.e., minimally fluid filled), which optimizes the valve response frequency and consistency of the dispense performance. Again the volume of dispense fluid is controlled 808 by software, and at the appropriate time aspiration is ended. The motive force of dispensing is provided by the pressurized minimally fluid filled system upstream of the dispense valve 302. Subsequently the air pressure valve 312 opens. The dispense valve 302 is backed by air pressure, the level of which is controlled by the software.

Prior to dispensing, a pre-dispense process beneficially may be applied to enhance liquid dispensing reliability. In the pre-dispense process, a relatively large pressure may be applied and the dispense valve 302 opened to initially dispense 812 a relative large droplet. At the same time, the dispense valve control pulse will be wider so that the dispense valve open time will be longer. The larger droplet dispense may contribute to reliable dispense liquid flow operation. After a few larger droplets are dispensed, in one embodiment in part of the slide holder but generally in any other location than the tissue, the valve control pulse width and dispensing pressure are reduced gradually 814 until the desired smaller droplets are dispensed. Then pressure, for example from 0 to 6 psi, and the valve opening pulse widths are set by software to the final dispensing parameters.

### 3. Nozzle Calibration

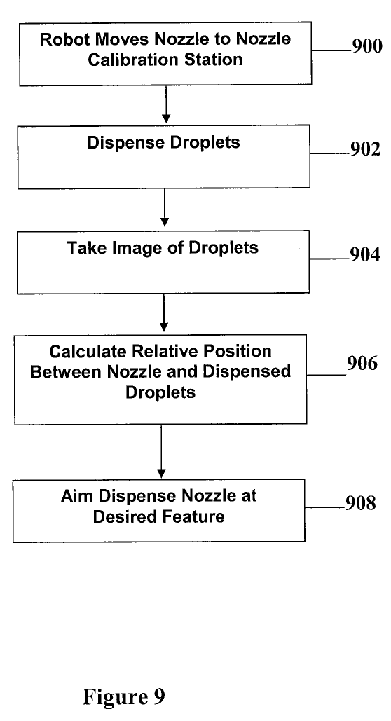

As illustrated in FIG. 1, the dispense head 110 is mounted on the Z drive 108, which is attached to the X,Y robotic carriage 106, giving the liquid handler 400, as shown in FIG. 4, movement in all three axes. After camera calibration and implementation of the dispensing routine, a calibration process as shown in flow diagram of FIG. 9, the robot 101 moves the nozzle 316 towards the nozzle calibration station 900 and dispenses one or several droplets 902. The image of the droplets is taken 904 and the relative position between the camera 114 and the placed droplets is calculated 906. Subsequently the robot 101 can aim the dispense nozzle 316 at any feature on the robot platform 102 based on what the robot vision can see. This calibration process may be particularly helpful in frequently encountered cases where, for example, the dispense nozzle 316 dispenses droplets with a lateral component rather than straight down.

In the initial dispense process, discussed below, nozzle dispense positioning can be further verified and calibrated during each nano-dispensing run. Real-time nozzle calibration may contribute to accurate and reliable liquid handling positioning.

### 4. Imaging Process and Liquid Handling Spot Generation

The high precision robot 101 moves the camera 114 through X,Y space and acquires multiple partial images of the object. Software then creates an object image using a tiling process in which these multiple partial object images are assembled to create the object image.

Initially, an operator mounts an object (e.g., a MALDI target containing a dried thin section tissue sample) for dispensing onto an object or target plate holder 124, as shown in FIG. 1. Then the application software in the computer is started. Based on the application, a light source 116 may be turned on to illuminate the object during imaging. Through image processing, liquid handling spot generation is derived when the image device allows automated or manual selection of droplet deposition coordinates displayed as an overlay on the object image. These coordinates will be used for droplet placement during liquid handling and will be exported in an XML file format for use by a downstream analytical device. The droplet deposition coordinates can be related to a fiducial used as a standard of reference for comparison or measurement attached or engraved on the object.

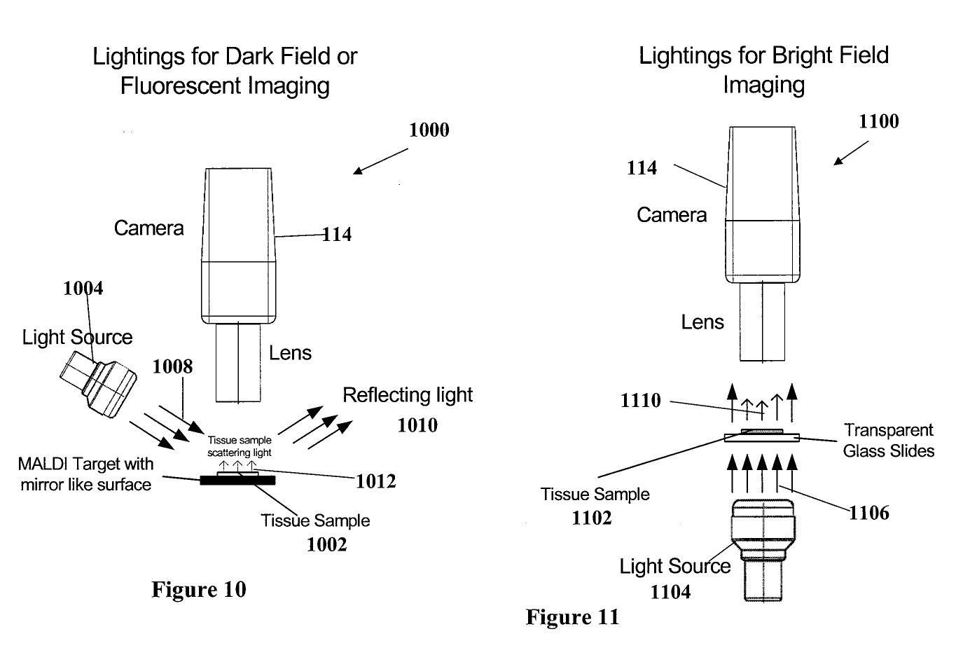

FIGS. 10 and 11 illustrate embodiments of illumination systems 1000 and 1100, respectively. In order to obtain acceptable object images, different illumination methods may be required. There are at least two general illumination methods that can be used for imaging in the present invention. The first method, shown in FIG. 10, called dark field illumination, illuminates a sample or object 1002 from the same side as the imaging device. During dark field illumination, the object 1002 is illuminated with a light source 1004 by illuminating a reflective substrate 1006 with light 1008 at an acute angle whereby minimal or no light rays are reflected into the imaging device 114, but the light 1010 is reflected to the opposite side of the imaging device 114. The acute angle θ is chosen such that a portion of the light scattered 1012 or emitted (e.g., fluorescence) by a sample or object 1002 on the surface of the substrate 1006 is captured by the imaging device 114. In one embodiment the angle θ may be on the order of 30 degrees. The light source 1004 includes but is not limited to light emitting diodes (LEDs) and cluster LEDs. The light source 1004 can be a point source or a two dimensional shape like a cluster or ring light source. For this illumination system 1000, a LED cluster device model no. 1156-W19-24V from SuperBrightLED of St. Louis, Mo. may be used.

The second method, shown in FIG. 11 and called bright field illumination, illuminates a sample or object 1102 with a light source 1104 from the side of the object opposed to the imaging device 114. During imaging, bright field illumination illuminates the object 1102 by impinging light 1106 on a transparent, partially transparent, or translucent substrate 1108 with the object 1102 on the surface of the substrate 1108. The substrate 1108 is placed between the light source 1104 and the imaging device 114. The light 1110 that passes through the object 1102 and substrate 1108 is captured by the imaging device 114. The light source 1104 includes but is not limited to LEDs and cluster LEDs.

In one embodiment, illuminated object images are obtained by an imaging device 114, such as a camera or image sensor, through an optical lens which may or may not be fitted with emission or other filter devices. Image data obtained from the camera or sensor is transferred to a computer for image storage and processing. Through manual, semi-automatic, or interactive and automated protocols, a droplet deposition pattern is generated for liquid handling. An operator can define a dispense pattern for the substrate or object image, or use an imported pattern or list of coordinates for liquid handling. An operator also can use computer software to interactively place, resize, drag, drop, and rotate the pattern to orient or align with the substrate or object, such as shown in FIG. 16. An operator also can invoke an automatic mode in which, through computer image processing, images are automatically analyzed in accordance with operator defined or pre-defined rules or heuristics for regions containing specified color(s), geometries, structures, features, shapes, intensity levels, and/or differences between or among regions on two or more images where said regions are automatically patterned for dispensing in accordance with operator defined or pre-defined rules or heuristics.

### 5. Liquid Handling Process

The dispense volume may be determined by the combination of upstream system pressure, as discussed above, and the spike and hold waveform driving the valve opening and closing generated by the electronics. A voltage spike is applied to open the dispense valve 302, and is maintained briefly. Then the voltage is dropped and held to avoid burnout of the valve before applying another spike to open the valve again. An interlaced dispensing mechanism may be used whereby alternate droplets may be deposited and allowed to dry before the system deposits the intervening droplets, which may result in denser placement of droplets. In addition, the combination of vision, dispense calibration and compensation, and a high precision robot platform may allow the system to repeatedly dispense the same or different liquids multiple times in an overlay at the same location with or without drying between dispense cycles.

In order to contribute to reliable dispensing, especially for some difficult liquids (e.g. MALDI matrix), an initialization process may be provided that is software controlled and coordinates the duration of the solenoid valve 302 drive circuit electronics' spike and hold pulse with the level of system pressure in the dispensing liquid flow path. The liquid dispensing can be carried out with high speed from location to location by moving the robot's X,Y linear motors to the specified X,Y droplet deposition coordinates. After a specified number of dispenses, a washing process, discussed below, may be introduced to clean the inside and outside of the dispense nozzle. These washing steps may be helpful since partial or full clogging of the nozzle will reduce the system reliability.

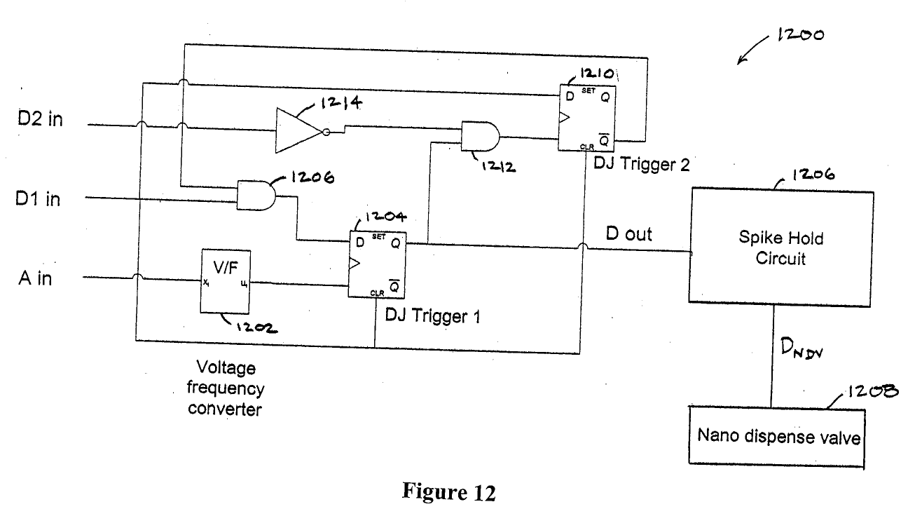

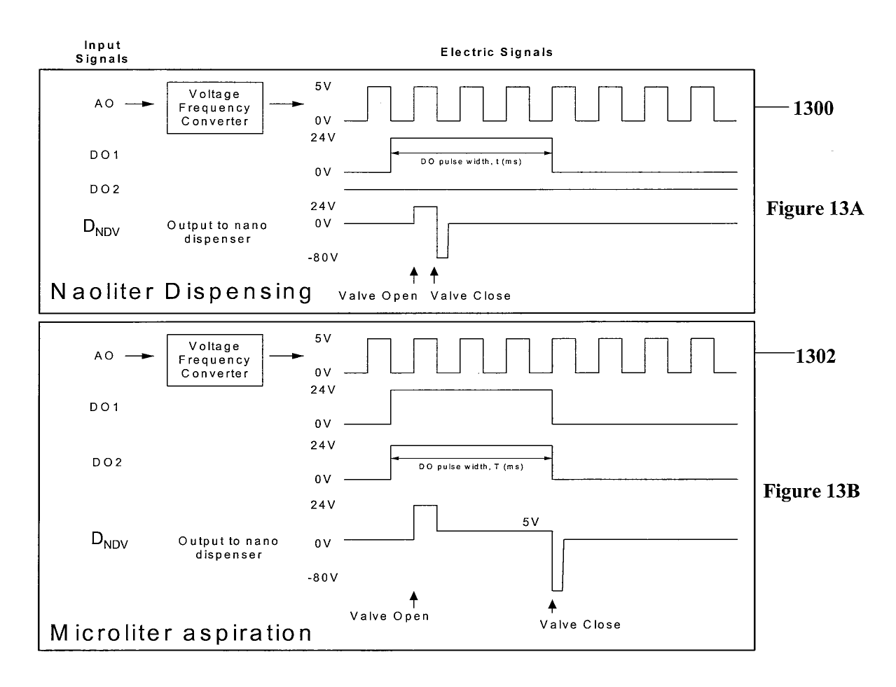

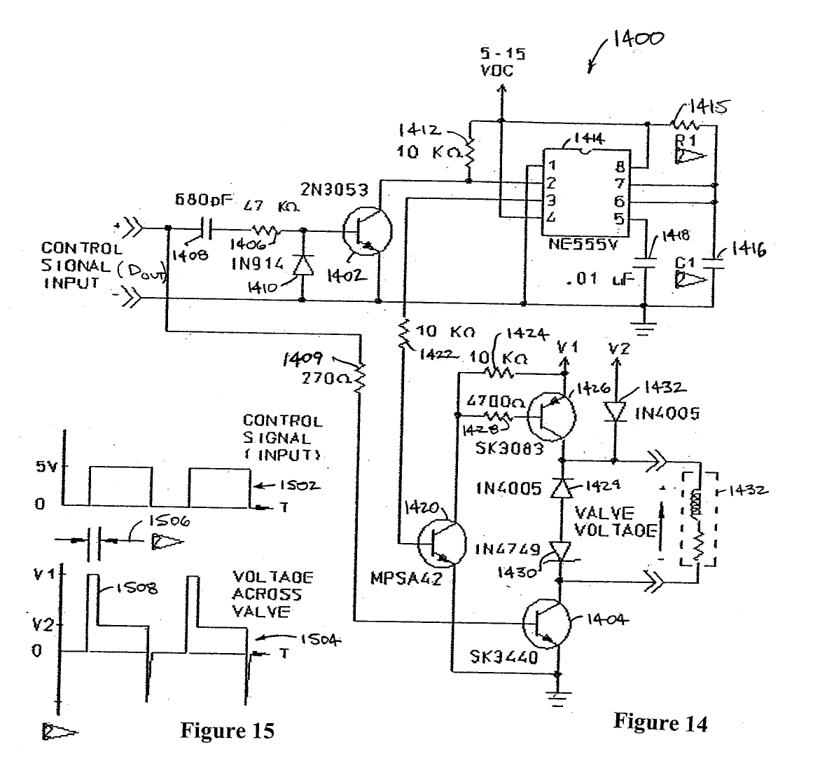

FIG. 12 is schematic diagram of an example of a nano dispense valve control circuit 1200 in accordance with an embodiment of the present invention. The control circuit 1200 may receive a D1, D2 and A input signals. These signals come from a control card that may be programmed through application software. The input signal A may be any type of periodic or sinusoidal signal that may be converted to a square wave clock signal or the like as illustrated in FIGS. 13A and 13B by a voltage frequency converter (V/F) 1202. The square wave signal may clock a first DJ flip-flop, latch or trigger 1204 (DJ Trigger 1). The output (Dout) of the control circuit 1200 may be applied to a spike hold circuit 1206. An example of a spike hold circuit 1400 that may be used for the spike hold circuit 1206 will be described in more detail with reference to FIG. 14. The output signal DNDV of the spike hold circuit 1206 controls the nano dispense valve 1208. The output signal DNDV and control of the nano dispense valve 1208 is illustrated in FIG. 13A for the nanoliter dispensing operation and in FIG. 13B for the microliter aspiration operation as described in more detail hereinbelow.

The D input to the first trigger 1204 may be from an AND gate 1206 which logically ANDs the D1 input and an inverted output ( Q̅) from a second DJ flip-flop or trigger 1210. The D1 input signal may be applied to the D input of the second DJ trigger 1210 and the J input may be from another AND gate 1212 which logically ANDs the Q output of the first DJ trigger 1204 and the complement or inverse of the D2 input inverted by an inverter 1214.

The nano dispense valve control circuit 1200 may allow the robot programmable control of the dispense valve opening pulse width to vary from about a microsecond or less to about a second or more. In the circuit, the voltage frequency converter (V/F) 1202 is used. The V/F converter 1202 produces a square wave train. In operation, when the square wave at the J or clock input to the first trigger 1204 goes from low to high and if the input D1 is high, the Q output of the first trigger 1204 will go to high. The Q output of the first DJ trigger 1204 being high and the D2 input being low will set the complimentary or inverted output ( Q̅) of the second DJ trigger 1210 high. Whenever D1 is low or the inverted output of the second trigger 1210 is low, the Q output of the first trigger 1204 will go low when the square wave goes high to clock the first trigger 1204.

FIG. 13A is an exemplary signal diagram 1300 for the nano dispense valve control circuit of FIG. 12 illustrating examples of signals A, D1, D2 and DNDV for nanoliter dispensing in accordance with an embodiment of the present invention. FIG. 13B is an exemplary signal diagram 1302 for the nano dispense valve control circuit of FIG. 12 illustrating an examples of signals A, D1, D2 and DNDV for microliter aspiration in accordance with an embodiment of the present invention. As previously discussed, two digital input signals (D1 and D2) and one analog output signal (A) may be used to control the circuit 1200. The analog signal is used to control the frequency of the output signal from the voltage/frequency converter. When D2 is low, D1 transitioning from a low to high will trigger a single DNDV output pulse. The pulse width is about equal to the pulse width of the output signal from the voltage/frequency converter 1202. This output pulse signal DNDV may vary from about ten to several hundred microseconds. The DNDV signal may be used to open and close the nano dispense valve during nano dispensing as illustrated in FIG. 13A.

When D2 is on or high, the output pulse DNDV width will be about the same as the pulse width of the output signal of the voltage frequency converter 1202. The DNDV pulse width may vary from about several hundred microseconds to several seconds as programmably controlled by the robot, which can be used for the aspiration process as illustrated in FIG. 1 3B.

FIG. 14 is an example of a spike hold circuit 1400 in accordance with an embodiment of the present invention. The spike hold circuit may be used for the spike hold circuit 1206 of FIG. 12. A control signal which may be output signal DOUT in FIG. 12 may drive the base of a first transistor 1402 and a second transistor 1404. The first transistor 1402 and the second transistor 1404 may be NPN transistors; although PNP transistors could also be used if the voltage polarities in the circuit 1400 are reversed. The base circuit of the first transistor may include a resistor 1406 and a capacitor 1408. The control signal may be applied to the base of the second transistor 1404 by about a 270 ohm base resistor 1409. A diode 1410 may be connected between the base and emitter of the first transistor 1402 to permit current to flow from the emitter to the base. The resistor 1408 may be about a 47 kilo ohm resistor and the capacitor 1410 may be about a 680 pico Farad capacitor to provide the proper bias on the base of first transistor 1402. A collector bias voltage of about 5 to about 15 volts DC may be applied to the collector of the first transistor 1402 by about a 10 kilo ohm resistor 1412. The collector of the first transistor 1402 may also be connected to pin 2 of a chip 1414, which is a timing chip that generates programmable pulse width and frequency.

The about 5-15 volts DC bias voltage may also be connected to pins 4 and 8 of the chip 1414. Pin 8 of the chip 1414 may be connected to pins 6 and 7 by a resistor R1 1415. Pin 6 may be connected to ground potential by a capacitor C1 1416 and pin 5 may be connected to ground potential by another capacitor 1418 that may be about a 0.01 micro Farad capacitor or the like. Pin 1 of the chip 1414 is also connected to ground potential.

Pin 3 of the chip 1414 may be connected to a base of a third transistor 1420 by a base resistor 1422. The third transistor 1420 may be a PNP transistor and the base resistor 1422 may have a resistance of about 10 kilo ohms. The emitter of the third transistor 1420 and the emitter of the second transistor 1404 may be connected to ground potential. The collector of the third transistor 1420 may be connected to a collector voltage V1 by a collector resistor 1424 that may be about 10 kilo ohms. The collector of the third transistor 1420 may also be connected to the base of a fourth transistor 1426 by a base resistor 1428. The fourth transistor 1426 may be a PNP transistor. The base resistor 1428 may be about a 4700 ohm resistor to provide proper bias of the fourth transistor 1426. The collector of the fourth transistor 1426 may be connected to the cathode of a diode 1429. The anode of the diode 1429 may be connected to the anode of a Zener diode 1430. The cathode of the Zener diode 1430 may be connected to the collector of the second transistor 1404. The valve control voltage or DNDV may be the voltage across the cathodes of diode 1429 and Zener diode 1430 which is applicable to the nano dispense valve 1432. The nano dispense valve 1432 is represented electrically in FIG. 14 by a resistor in series with an inductor (RL circuit). Another diode 1434 may apply a voltage V2 to the nano dispense valve 1432 when the diodes 1429 and 1430 are not conducting.

FIG. 15 illustrates an example of operation of the spike hold circuit 1400. For a square wave input control voltage signal 1502, the voltage across the valve 1432 would appear similar to signal 1504. The duration 1506 of a pulse 1508 would be a function of R1 and C1 (V1 pulse duration=1.1×R1×C1). Accordingly, the values of R1 and C1 may be adjusted to provide the desired pulse duration. As illustrated in FIG. 15, a pulse or high control signal will cause transistors 1426 and 1404 to conduct and forward bias the diodes 1429 and 1430. Voltage V1 will then be present across the valve 1432 for a duration corresponding to the values of R1 and C1. One or both of transistors 1404 and 1426 will then turn off and voltage V2 will appear across the valve 1432. The circuit 1400 is adapted to prevent the valve's maximum power rating from being exceeded.

As previously discussed, for liquid handling, reagents, samples, or solvents can be aspirated from a variety of source containers such as tubes, microwells, or Eppendorf type containers. After the pre-dispense process, the robot 101 will move the dispense head 110 to the object's first dispense location and immediately commence the object dispensing operation. The dispense sequence is software controlled and uses the droplet locations determined during image processing. The liquid can be dispensed at the specified X,Y droplet coordinates. The Z coordinate can be predetermined for an object type and stored in a configuration database. The dispense locations are stored in an XML file that the robot software accesses to determine the order and location for each dispense.

The computer software control may provide improved reliability for nanoliter liquid handling, while, at the same time, may limit the need for human intervention, increase reproducibility, enable walkaway automation, and decrease the number of potential human errors.

Based on the software configuration, an operator can specify the number of dispenses before washing the liquid handling nozzles 316. For example, an operator may want to dispense the first 200 droplets and then carry out a wash and aspiration process before dispensing the remaining droplets. The frequency of washing is largely determined empirically based on the behavior of the dispense liquid 320; however, the larger the number of dispenses the more frequent the wash cycles. Washing in an ultrasonic bath 130 to thoroughly clean crystal build up on the nozzle orifice 316 is recommended and significantly improves the dispensing positional accuracy and the consistency of the dispense droplet size. The robotic system 101 will automatically wash the nozzle 316 after a specified number of dispenses dependent upon the composition of the dispense solution, which is configurable by the operator. To maintain the system, washing is needed before and after each liquid handling cycle.

Some dispense solutions contain very high concentrated salt in volatile solvents, which may rapidly form crystals at the tip of the nozzle orifice 316. In one embodiment, a sapphire orifice of 75 micrometer inside diameter is used and can be easily clogged by build up of the salt crystals. To help prevent the nozzle 316 from clogging, high dispensing speed may be provided. Two significant advantages come with the high speed dispense. First, the high speed dispense can spot large amount of droplets before clogging happens. Second, high speed dispenses make faster liquid flow that slows down the crystal build up at the tip of the nozzle orifice.

However, the high speed dispense requires the robot 101 to move quickly and precisely to all positions the operator selects as the dispense pattern. In one embodiment, the Cartesian robot 101 with linear servomotor and distributed closed-loop proportional-integral-derivative (PID) motion control system meets these requirements. A dispense speed higher than 2 Hz, for example, and in some cases higher than 10 Hz, may be achieved.

### 6. Post Liquid Handling Process

After the liquid handling process is completed, the imaging device with illumination can be used to obtain images of the dispense pattern. From these images, post process inspection, quality control, and verification of liquid handling can be accessed. Also, the liquid handling results can be stored using image files. Using a specific defined data format (for example, XML data format), the actual dispensed pattern information can be saved automatically. The dispensed pattern file can be used by another instrument for further analysis or action (e.g., mass spectrometry). Thus, the system may export the coordinates for dispensing as determined by the operator prior to dispensing and/or export the actual coordinates of the dispensed material as determined through post dispense image analysis. A comparison of the differences can be used to improve dispense protocols and to formulate well behaved materials used in dispensing.

After completion of liquid handling for all of the objects, the operator or robot software may execute a final wash and clean up process to maintain the system in good working order.

The hardware configuration, electronic and software control, and methodology for aspiration, dispensing and in-process quality control of the present invention have been calculated to result in reliable dispenses for less than approximately 10 nanoliters, and more particularly, less than approximately 5 nanoliters, for example, from approximately 2 to 2.5 up to 4 nanoliters. The methods and apparatus of the present invention are believed to be capable of dispensing down to approximately 1 nanoliter or less. Such volumes reflect a 10-20 fold improvement over existing solenoid based dispensers.

FIG. 16 shows a matrix spot array (10×10) with pitch distance of 0.5 mm. Interactively placement, resizing, dragging, dropping, and rotating the pattern to orient or align with the substrate or object may be performed as shown in views A, B, and C. A labeled tissue sample image is also shown in FIG. 16.

Specific embodiments of an invention are described herein. One of ordinary skill in the art of small volume liquid handling systems will recognize that the invention has other applications in other environments. In fact, many embodiments and implementations are possible. For example, the present invention could be applied to applications like high throughput compound screening, and DNA, protein and cell array studies. In particular, this invention may be applied in proteomics and drug study applications in which protein or small molecule drug (and metabolites) spatial distribution information is profiled using mass spectrometric imaging techniques. Proteomics involves the identification and characterization of cellular proteins and the determination of their role in cell function, disease and response to exogenous or external factors and stimuli such as drugs, toxicants, and stress.

Another use of this invention is to enable the identification of proteins, protein structures, interactions and pathways so that new disease markers and drug targets can be identified that will help create new products to prevent, diagnose and treat disease. A further use of this invention is to enable the determination of the spatial accumulation of small molecule drugs and their metabolites in target tissues or their relative distribution in diseased versus normal tissues using mass spectrometry analysis.

The recitation “means for” is intended to evoke a means-plus-function reading of an element in a claim, whereas, any elements that do not specifically use the recitation “means for,” are not intended to be read as means-plus-function elements, even if they otherwise include the word “means.” The following claims are in no way intended to limit the scope of the invention to the specific embodiments described.

That which is claimed is:

1. A system that integrates vision with small-volume dispensing comprising:
a platform comprising a platform base and a movable carriage positioned above the platform base:
a modular assembly connected to the movable carriage comprising:
a liquid dispensing unit comprising
a high speed solenoid valve;
a reservoir downstream of the solenoid valve;
an orifice fitted to the downstream end of the solenoid valve; and
a connector connected to a valved pressure system and an aspiration device; and
a Z axis drive for moving the dispensing unit in the Z direction;
an imaging device; and
a solenoid valve electronic control circuit for control of the dispensing unit.

2. The system of claim 1 wherein the liquid dispensing unit comprises:
a solenoid valve having a frequency of about 800 to 1400 Hz;
a short liquid reservoir tubing downstream of the valve communicatively connected to the valve and a sapphire orifice nozzle through with the device aspirates and dispensing liquid;
an interface tube located upstream of the solenoid valve containing a small volume of prime fluid so that a certain small volume of fluid is maintained above and below the solenoid valve during dispensing.

3. The system of claim 1 wherein the platform comprises support arms positioned on opposite sides of the platform and rising above the platform base, wherein the movable carriage is positioned on the support arms and spanning therebetween.

4. The system of claim 1, wherein support arms comprise a surface whereon the movable carriage is movable in the X direction along at least a portion of the surface.

5. The system of claim 1, further comprising:
a control unit positioned on the movable carriage and having movement in the Y direction along at least a portion of the movable carriage, wherein the liquid dispensing is communicatively connected to the control unit.

6. The system of claim 1, further comprising a working surface positioned under at least a portion of the movable carriage; and
an illumination system positioned above and/or below the working surface.

7. The system of claim 1, wherein the imaging device is positioned adjacent to the liquid handling dispensing assembly.

8. The system of claim 1, wherein the liquid dispensing unit dispenses about 5 nanoliters or less at one time.

9. The system of claim 1, wherein the liquid dispensing unit further comprises a pneumatic-hydraulic system upstream of the solenoid valve, wherein the pneumatic-hydraulic system comprises a pneumatic pressure valve.

10. The system of claim 9, wherein the pneumatic-hydraulic system further comprises a connector upstream of and proximate to the solenoid valve and having first, second, and third arms extending from a branch.

11. The system of claim 9, further comprising an aspiration device, and wherein the upstream end of the solenoid valve and the first arm of the connector are connected, the second arm and the aspiration device are connected, and the third arm and the pneumatic pressure valve are connected.

12. The system of claim 2, wherein the liquid comprises a prime liquid that is present both upstream and downstream of the solenoid valve during dispensing, and a dispense liquid is downstream of the prime liquid.

13. The system of claim 1, wherein the system further comprises an electronic control circuit for operating the high speed solenoid valve comprising:
a first digital input signal;
a second digital input signal; and
one analog input signal for controlling a voltage/frequency converter;
wherein the input signals control the solenoid valve.

14. The system of claim 13, wherein when the second digital output is off, the first digital output on/off will trigger a single output pulse, wherein the pulse varies from about ten to over 200 hundred microseconds.

15. The system of claim 14, wherein the pulse controls opening and closing of the solenoid valve during dispensing.

16. The system of claim 1, wherein the imaging device has movement in at least the X and Y direction.

17. The system of claim 16, wherein the illumination system uses dark field illumination or bright field to illuminate the object or substrate for imaging.

18. The system of claim 1, where the imaging device is a camera having a diagonal field of view (FOV).

19. The system of claim 6, wherein the working surface further comprises a camera calibration target with a diameter that is a fraction of the diagonal of the FOV of the camera and an ultrasonic washer for cleaning of the orifice.

20. A method for dispensing small volume liquids with imaging thereof, the method comprising:
providing an X,Y carriage of a Cartesian robot that includes a platform;
mounting a camera on the X,Y carriage;
mounting a dispensing device on the on the X,Y carriage;
imaging an object or substrate with the camera;
defining or importing and overlaying a dispense pattern for the object or substrate image; and
executing a dispensing protocol in which droplets are dispensed from the dispensing device at the same or different locations on the physical object or substrate in accordance with the pattern specified for the image.

21. The method of claim 21, wherein the camera has a diagonal field of view (FOV) and the method further comprises:
moving the camera towards a camera calibration target, wherein the target has a diameter that is a fraction of the diagonal of the FOV of the camera; and
finding the center of gravity of the target with image processing software;
moving the robot step-by-step through an array that starts with the target in one corner of the FOV and ends when the target is in the opposite corner of the FOV;
acquiring the image of the target; and
recording the center of gravity.

22. The method of claim 21, further comprising:
moving the dispensing device to an imaging device calibration station;
dispensing one or more droplets, first done in an initial dispense process;
taking the image of the droplets;
calculating the relative position between the imaging device and the dispense nozzle;
aiming the dispense nozzle with the robot at any feature on the robot platform based on what the imaging device can see; and
optionally, verifying or re-calibrating dispense positioning during each initial dispense process.

23. The method of claim 21, further comprising reconstructing a subsequently acquired image by warping the image from the target center of gravity to the robot-moving array.

24. The method of claim 20, wherein object or substrate is MALDI matrix.

25. The method of claim 20, wherein the dispense pattern may be either a row column matrix or a set of points on the object or substrate image, and further comprising interactively orienting, aligning, or a combination thereof, the pattern with the object or substrate.

26. The method of claim 20, further comprising using dark field illumination or bright field illumination to illuminate the object or substrate for imaging.

27. The method of claim 26, wherein the dark field illumination comprises illuminating a reflective substrate at an acute angle such that substantially no light rays are reflected into the imaging device and such that a portion of the light scattered or emitted by a sample or object on the surface of the substrate is captured by the imaging device.

28. The method of claim 26, wherein the bright field illumination comprises illuminating with a light source a transparent, partially transparent, or translucent substrate containing a sample or object on the surface of the substrate, and the substrate is placed between the light source and the imaging device.

29. The method of claim 20, wherein dispensing from the dispensing device includes a purging step before final dispensing, the purging step comprising:
providing a valved, pressurized, pneumatic-hydraulic system including a pneumatic pressure valve;
closing the pneumatic pressure valve;
providing an aspiration device in pneumatic-hydraulic communication with the pneumatic-hydraulic system downstream of the pneumatic pressure valve;
aspirating system prime fluid into the system until is it downstream and upstream of a solenoid dispense valve;
aspirating dispense fluid into the system, remaining downstream of the dispense valve;
opening the pneumatic pressure valve;
backing the solenoid valve with pneumatic pressure;
applying pressure to the system to initialize relatively large droplet size dispenses; and
reducing the pressure and the valve opening pulse width to the final dispensing parameters.

30. The method of claim 29, wherein flow of aspiration liquids is substantially laminar.

31. The method of claim 20, wherein dispensing liquids are dispensed at a frequency of about 10 Hz or greater, thereby reducing orifice clogging of the dispensing device.

32. The method of claim 20, wherein droplets of at least one type of liquid is dispensed from the dispensing device at the same location, comprising:
depositing droplets at a first location;
moving the dispensing device to a different location for additional dispensing of at least one droplet;
returning the dispensing device to the first location; and
depositing droplets at the first location.

33. The method of claim 20, further comprising;
pre-determining a pattern for droplet placement on the object;
depositing initial droplets on the object, omitting placement at contiguous, intervening placement locations;
depositing subsequent droplets at intervening placement locations, resulting in denser placement of droplets.
